(19) United States
(12) Patent Application Publication
(10) Pub. No.: US 2021/0380490 A1
(43) Pub. Date: Dec. 9, 2021

(54) METHOD FOR FINELY PROCESSING NONMETALLIC MINERAL

(71) Applicant: Shandong University of Science and Technology, Qingdao (CN)

(72) Inventors: Li Wang, Qingdao (CN); Dengzheng Gao, Qingdao (CN); Lihua Liu, Qingdao (CN); Qingbin Guo, Qingdao (CN); Zhen Xue, Qingdao (CN)

(73) Assignee: Shandong University of Science and Technology, Qingdao (CN)

(21) Appl. No.: 17/188,280

(22) Filed: Mar. 1, 2021

(30) Foreign Application Priority Data
Jun. 9, 2020 (CN) 202010519320.3

(51) Int. Cl. C04B 35/626; B03C 1/035; B03C 1/10; C04B 35/628; B05B 1/04

(52) U.S. Cl. CPC C04B 35/6261; C04B 35/62655; B03C 1/035; B03C 2201/20; C04B 35/628; B05B 1/04; C04B 35/62675; B03C 1/10

(57) ABSTRACT

The present disclosure discloses a method for finely processing a nonmetallic material, including: crushing a nonmetallic mineral to obtain a nonmetallic block, drying at ambient temperature, coarsely grinding the dried nonmetallic block to obtain coarsely ground particles, subjecting the coarsely ground particles to a second grinding, and then ball milling in a ball mill, drying and sieving to obtain a powder with various particle sizes; classifying and marking the powder to determine the grade and corresponding use of the powder; modifying the nonmetallic mineral powder in a modification device, grinding by a drum ultra-fine vibration mill to obtain a modified powder; calcining the modified powder, then cooling at ambient temperature, mixing with a strong alkali solution to react in a water bath; adding an excessive hydrochloric acid solution, and filtering, washing and drying the resulting filter cake to obtain a product.

### CROSS REFERENCE TO RELATED APPLICATION

This application claims the priority of Chinese Patent Application No. 202010519320.3, entitled “Method for finely processing nonmetallic mineral” filed with the China National Intellectual Property Administration on Jun. 9, 2020, which is incorporated herein by reference in its entirety.

### TECHNICAL FIELD

The present disclosure belongs to the technical field of materials processing, and particularly relates to a method for finely processing a nonmetallic material.

### BACKGROUND

At present, nonmetallic minerals are closely related to industries such as high-tech and new material industries, traditional industrial upgrading and eco-environmental protection. The nonmetallic minerals are not only widely used in traditional industries such as building materials, metallurgy, chemical industry, transportation, machinery and light industry, but also have broad potential markets in high-tech industries such as electronic information, biomedicine, new energy, new materials and aerospace; moreover, they are efficient and cheap materials for environmental protection and ecological construction. However, the existing non-metallic minerals have a low development rate and utilization rate, and have not been finely processed, and it is difficult to improve their value.

As can be seen from the above analysis, the prior art has the following problems: the existing non-metallic mineral materials have a low development rate and utilization rate, and have not been finely processed, and it is difficult to improve their value.

### SUMMARY

To address the problems existing in the prior art, the present disclosure provides a method for finely processing nonmetallic minerals.

The present disclosure is realized by a method for finely processing a nonmetallic mineral, comprising,

step 1, coarsely crushing a nonmetallic mineral to be processed by a jaw crusher or a hammer mill to obtain nonmetallic blocks; dry removing coarse granular magnetic irons with a high specific magnetization coefficient from the nonmetallic blocks by an open gradient drum and/or roller low magnetic field magnetic separator with a sorting magnetic flux density of 150-200 mT;

step 2, drying the nonmetallic blocks after removing coarse granular magnetic irons with a high specific magnetization coefficient obtained in step 1 at a temperature not higher than 300° C., and coarsely grinding at ambient temperature to obtain coarsely ground particles; subjecting the coarsely ground particles to a second grinding by a cyclone crusher, to obtain a secondary ground powder;

step 3, placing the secondary ground powder in a ball mill, dropwise adding a small amount of absolute ethyl alcohol, and mixing uniformly to obtain a mixture; ball milling the mixture for 10-15 min with zirconium dioxide grinding balls as a ball milling medium, to obtain a ball milled nonmetallic mineral powder; drying and sieving the ball milled nonmetallic mineral powder, to obtain a powder with various particle sizes;

step 4, wet removing fine granular metallic irons with a medium specific magnetization coefficient from the powder with various sizes by a closed gradient reciprocating permanent magnet multi-gradient magnetic separator with a sorting background magnetic field having a magnetic flux density of 300-600 mT and/or vertical ring multi-gradient magnetic separator with a sorting background magnetic field having a magnetic flux density of 600-1000 mT;

step 5, passing the powder with various particle sizes obtained in step 4 through two hydrocyclones with diameters of 75 mm and 50 mm in sequence to finely classify and mark the powder, thereby determining the grade and corresponding use of the powder;

step 6, selecting a nonmetallic mineral powder with a particle size lower than 150 μm obtained in step 5 and feeding the nonmetallic mineral powder with a particle size lower than 150 μm into a raw material bin inside a modification device through a feeding pipeline, and uniformly dispersing the powder onto the surface of a pulse material dispersion filter bag by means of a blower mounted on the modification device;

step 7, coating a surface modifier on the nonmetallic mineral powder dispersed in step 6 by a fan-shaped high-pressure quantitative atomizing nozzle during the process that the nonmetallic mineral powder leaves the pulse material dispersion filter bag and descends, to obtain a coated nonmetallic mineral powder; drying the coated nonmetallic mineral powder by hot air delivered in an air supply device, to obtained a dried material;

step 8, re-feeding the dried material obtained in step 7 after descending to a collection device for the nonmetallic mineral powder into the fan-shaped high-pressure quantitative atomizing nozzle through a preheating pipeline by a distribution pipe and a distribution rotary valve arranged below the raw material bin for coating modification cycle for 3-5 times; discharging the resulting material after coating modification from the modification device through an discharge pipeline, and grinding by a drum ultra-fine vibration mill, to obtain a modified nonmetallic mineral powder;

step 9, calcining the modified nonmetallic mineral powder obtained in step 8 in a calciner, cooling, and crushing to an extent that the powder can pass through a 200-250 mesh sieve, to obtain a calcined modified nonmetallic mineral powder;

step 10, uniformly mixing the calcined modified nonmetallic mineral powder obtained in step 9 with a strong alkali solution in a mass ratio of 1:(3-8) to obtain a mixed liquid, and placing the mixed liquid in a thermostat water bath to react at a temperature of 60-90° C. for 2-5 h, to obtain a reacted mixed liquid;

step 11, slowly adding a hydrochloric acid solution into the reacted mixed liquid obtained in step 10 until the hydrochloric acid in the reacted mixed liquid is excessive, to obtain a mixed liquid added with hydrochloric acid solution; filtering the mixed liquid added with hydrochloric acid solution to obtain a filter cake, circularly washing the filter cake with water and filtering until the filter cake is neutral, and then drying the resulting filter cake, to obtain a purified nonmetallic mineral powder.

In some embodiments, in step 1, the nonmetallic mineral is at least one selected from the group consisting of graphite, crystal, barite, corundum, asbestos, mica, gypsum, fluorite, gem, jade, agate, limestone, dolomite, quartzite, diatomaceous earth, ceramic clay, refractory clay, marble, granite, salt ore and phosphate ore.

In some embodiments, in step 6, the modification device is controlled at a temperature of 150-180° C.

In some embodiments, in step 6, the pulse material dispersion filter bag is run by means of a blower at an air flow rate of 10000-12000 m³/min.

In some embodiments, in step 7, the surface modifier is at least one selected from the group consisting of a silane modifier, a titanate modifier, an aluminate modifier and a stearate modifier.

In some embodiments, in step 8, the grinding by a drum ultra-fine vibration mill is carried out for 30-60 min with ceramic balls as a grinding medium, and a weight ratio of the balls to the material is in a range of (8-10):1.

In some embodiments, in step 9, the modified nonmetallic mineral powder is calcined in a calciner at a temperature of 800-1200° C. for 5-8 h.

In some embodiments, in step 10, the strong alkali is at least one selected from the group consisting of sodium hydroxide, potassium hydroxide and lithium hydroxide; a concentration of strong alkali in the strong alkali solution is in a range of 4-6 mol/L.

In some embodiments, in step 11, a concentration of hydrochloric acid in the hydrochloric acid solution is in a range of 0.5-1 mol/L.

In some embodiments, in step 11, the filter cake is washed with water for 3-4 times, and dried in an oven at a temperature of 60-100° C. for 0.5-2.5 h.

In combination with all the above technical solutions, it can be seen that the present disclosure has the following advantages and beneficial effects: in the present disclosure, by the method in which a nonmetallic mineral is fine ground, classified, modified and purified, it is possible to realize fine processing of the nonmetallic mineral, and the obtained ultra-fine nonmetallic mineral has a particle size lower than 200 nm, and has less impurities and a better performance.

The processing method provided by the present disclosure solves the technical problems in preparing ultra-fine particles, thereby widening the application of the ultra-fine nonmetallic natural mineral in the fields such as plastics, coatings, rubber, paper making, medicine, ceramics and composite materials.

### BRIEF DESCRIPTION OF THE DRAWINGS

In order to describe the technical solution of the embodiments of the present disclosure more clearly, the drawings used in the embodiments of the present disclosure will be briefly introduced below. Obviously, the drawings described below are only some embodiments of the present disclosure. For those of ordinary skill in the art, other drawings could be obtained according to these drawings without paying creative labor.

FIG. 1 shows a flow chart of a method for finely processing a nonmetallic mineral according to embodiment(s) of the present disclosure.

FIG. 2 shows a flow chart of a process for ball milling a nonmetallic mineral particle after the second grinding in a ball mill according to embodiment(s) of the present disclosure.

FIG. 3 shows a flow chart of a process for modifying a nonmetallic mineral powder according to embodiment(s) of the present disclosure.

FIG. 4 shows a flow chart of a process for purifying a modified nonmetallic mineral powder according to embodiment(s) of the present disclosure.

FIGS. 5-7 show the SEM images of the products after finely processing nonmetallic minerals according to the examples of the present disclosure.

### DETAILED DESCRIPTION

In order to make the objective, technical solutions and advantages of the present disclosure clearer and more understandable, the present disclosure will be further described in detail with reference to embodiments below. It should be understood that the specific embodiments described herein are only intended to illustrate but not intended to limit the present disclosure.

In view of the problems existing in the prior art, the present disclosure provides a method for finely processing a nonmetallic mineral, which will be described in detail with reference to the drawings.

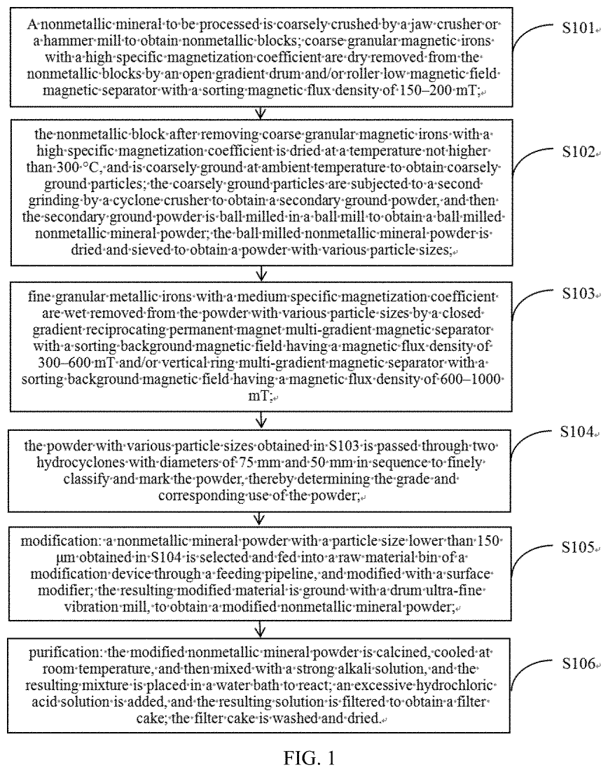

As shown in FIG. 1, an embodiment of the present disclosure provides a method for finely processing a nonmetallic mineral, comprising,

S101, a nonmetallic mineral to be processed is coarsely crushed by a jaw crusher or a hammer mill to obtain nonmetallic blocks; coarse granular magnetic irons with a high specific magnetization coefficient are dry removed from the nonmetallic blocks by an open gradient drum and/or roller low magnetic field magnetic separator with a sorting magnetic flux density of 150-200 mT;

S102, the nonmetallic block after removing coarse granular magnetic irons with a high specific magnetization coefficient is dried at a temperature not higher than 300° C., and is coarsely ground at ambient temperature to obtain coarsely ground particles; the coarsely ground particles are subjected to a second grinding by a cyclone crusher to obtain a secondary ground powder, and then the secondary ground powder is ball milled in a ball mill to obtain a ball milled nonmetallic mineral powder; the ball milled nonmetallic mineral powder is dried and sieved to obtain a powder with various particle sizes;

S103, fine granular metallic irons with a medium specific magnetization coefficient are wet removed from the powder with various particle sizes by a closed gradient reciprocating permanent magnet multi-gradient magnetic separator with a sorting background magnetic field having a magnetic flux density of 300-600 mT and/or vertical ring multi-gradient magnetic separator with a sorting background magnetic field having a magnetic flux density of 600-1000 mT;

S104, the powder with various particle sizes obtained in S103 is passed through two hydrocyclones with diameters of 75 mm and 50 mm in sequence to finely classify and mark the powder, thereby determining the grade and corresponding use of the powder;

S105, modification: a nonmetallic mineral powder with a particle size lower than 150 μm obtained in S104 is selected and fed into a raw material bin of a modification device through a feeding pipeline, and modified with a surface modifier; the resulting modified material is ground with a drum ultra-fine vibration mill, to obtain a modified nonmetallic mineral powder;

S106, purification: the modified nonmetallic mineral powder is calcined, cooled at room temperature, and then mixed with a strong alkali solution, and the resulting mixture is placed in a water bath to react; an excessive hydrochloric acid solution is added, and the resulting solution is filtered to obtain a filter cake; the filter cake is washed and dried.

In this embodiment of the present disclosure, the nonmetallic mineral is at least one selected from the group consisting of graphite, crystal, barite, corundum, asbestos, mica, gypsum, fluorite, gem, jade, agate, limestone, dolomite, quartzite, diatomaceous earth, ceramic clay, refractory clay, marble, granite, salt ore and phosphate ore.

The technical solution of the present disclosure will be further described with specific examples below.

### Example 1

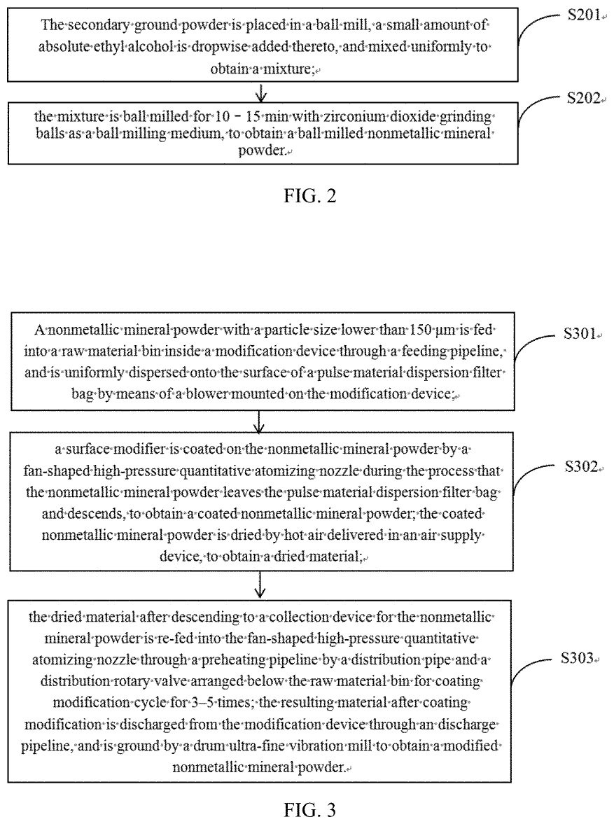

The method for finely processing a nonmetallic mineral according to this example of the present disclosure is shown in FIG. 1, and as a preferred embodiment, it is shown in FIG. 2. The process for ball milling the nonmetallic mineral particles after the second grinding in a ball mill according to this example of the present disclosure comprises:

S201, the secondary ground powder is placed in a ball mill, a small amount of absolute ethyl alcohol is dropwise added thereto, and mixed uniformly to obtain a mixture; and

S202, the mixture is ball milled for 10-15 min with zirconium dioxide grinding balls as a ball milling medium, to obtain a ball milled nonmetallic mineral powder.

### Example 2

The method for finely processing a nonmetallic mineral according to this example of the present disclosure is shown in FIG. 1, and as a preferred embodiment, it is shown in FIG. 3. The process for modifying the nonmetallic mineral powder according to this example of the present disclosure comprises:

S301, a nonmetallic mineral powder with a particle size lower than 150 μm is fed into a raw material bin inside a modification device through a feeding pipeline, and is uniformly dispersed onto the surface of a pulse material dispersion filter bag by means of a blower mounted on the modification device;

S302, a surface modifier is coated on the nonmetallic mineral powder by a fan-shaped high-pressure quantitative atomizing nozzle during the process that the nonmetallic mineral powder leaves the pulse material dispersion filter bag and descends, to obtain a coated nonmetallic mineral powder; the coated nonmetallic mineral powder is dried by hot air delivered in an air supply device, to obtain a dried material;

S303, the dried material after descending to a collection device for the nonmetallic mineral powder is re-fed into the fan-shaped high-pressure quantitative atomizing nozzle through a preheating pipeline by a distribution pipe and a distribution rotary valve arranged below the raw material bin for coating modification cycle for 3-5 times; the resulting material after coating modification is discharged from the modification device through an discharge pipeline, and is ground by a drum ultra-fine vibration mill to obtain a modified nonmetallic mineral powder.

In this example of the present disclosure, the modification device is controlled at a temperature of 150-180° C.

In this example of the present disclosure, the pulse material dispersion filter bag is run by means of a blower at an air flow rate of 10000-12000 m³/mm.

In this example of the present disclosure, the surface modifier is at least one selected from the group consisting of a silane modifier, a titanate modifier, an aluminate modifier and a stearate modifier.

In this example of the present disclosure, the grinding by a drum ultra-fine vibration mill is carried out for 30-60 min with ceramic balls as a grinding medium, and a weight ratio of the balls to the material is in a range of (8-10):1.

### Example 3

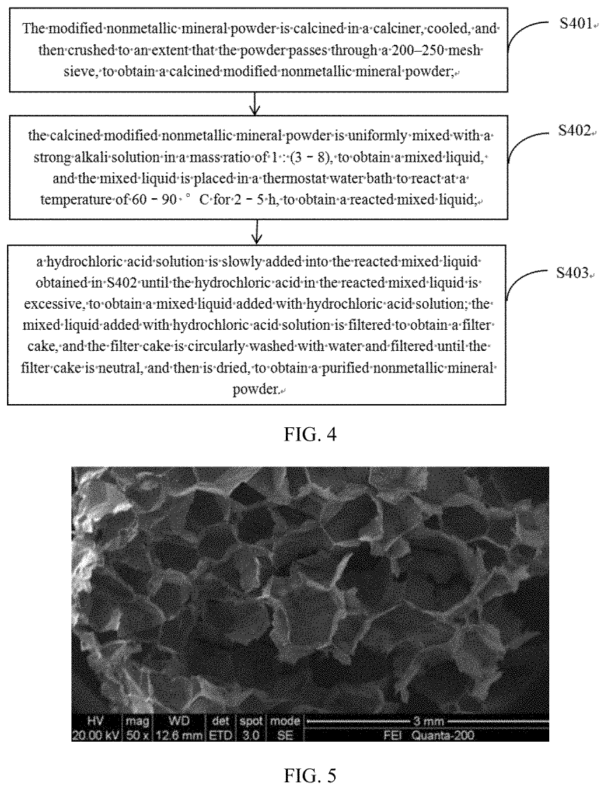

The method for finely processing nonmetallic minerals according to this example of the present disclosure is shown in FIG. 1, and as a preferred embodiment, it is shown in FIG. 4. The process for purifying the modified nonmetallic mineral powder according to this example of the present disclosure comprises:

S401, the modified nonmetallic mineral powder is calcined in a calciner, cooled, and then crushed to an extent that the powder passes through a 200-250 mesh sieve, to obtain a calcined modified nonmetallic mineral powder;

S402, the calcined modified nonmetallic mineral powder is uniformly mixed with a strong alkali solution in a mass ratio of 1:(3-8), to obtain a mixed liquid, and the mixed liquid is placed in a thermostat water bath to react at a temperature of 60-90° C. for 2-5 h, to obtain a reacted mixed liquid;

S403, a hydrochloric acid solution is slowly added into the reacted mixed liquid obtained in S402 until the hydrochloric acid in the reacted mixed liquid is excessive, to obtain a mixed liquid added with hydrochloric acid solution; the mixed liquid added with hydrochloric acid solution is filtered to obtain a filter cake, and the filter cake is circularly washed with water and filtered until the filter cake is neutral, and then is dried, to obtain a purified nonmetallic mineral powder.

In this example of the present disclosure, the modified nonmetallic mineral powder is calcined in a calciner at a temperature of 800-1200° C. for 5-8 h.

In this example of the present disclosure, the strong alkali is at least one selected from the group consisting of sodium hydroxide, potassium hydroxide and lithium hydroxide; a concentration of the strong alkali in the strong alkali solution is in a range of 4-6 mol/L.

In this example of the present disclosure, a concentration of the hydrochloric acid in the hydrochloric acid solution is in a range of 0.5-1 mol/L.

In this example of the present disclosure, the filter cake is washed with water for 3-4 times, and dried in an oven at a temperature of 60-100° C. for 0.5-2.5 h.

### Example 4

A graphite was crushed to blocks, and the blocks were dried at ambient temperature, and were coarsely ground to obtain coarsely ground particles; the coarsely ground particles were subjected to a second grinding, and then ball milled in a ball mill to obtain a ball milled powder; the ball milled powder was sieved to obtain a powder with various sizes; the powder with various sizes was classified and marked, to determine the grade and corresponding use of the powder;

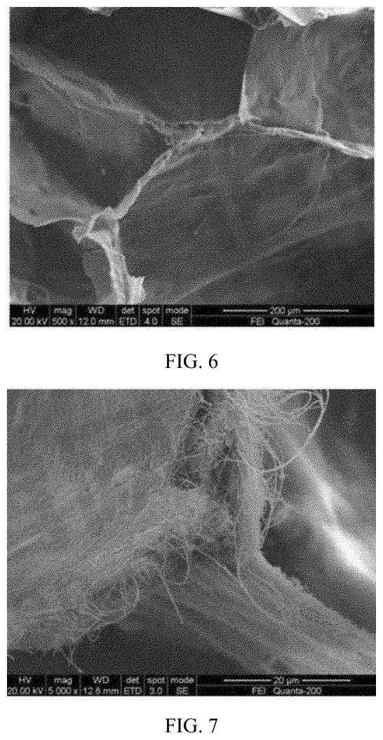

a silane modifier was added into the graphite powder with a particle size lower than 150 μm; the resulting mixture was ground with a drum ultra-fine vibration mill to obtain a modified powder; the modified powder was calcined at 1000° C. for 6 h, and then cooled at ambient temperature; the cooled modified powder was mixed with a sodium hydroxide solution for reacting in a water bath for 5 h to obtain a reacted mixed liquid; an excessive hydrochloric acid solution was added into the reacted mixed liquid, and the resulting mixed liquid was filtered to obtain a filter cake; the filter cake was washed and dried to obtain a product that was finely processed from the nonmetallic mineral, and the SEM images of the product were shown in FIGS. 5-7.

The above are only preferred embodiments of the present disclosure, but the protection scope of the present disclosure is not limited to this. Any modification, equivalent substitution and improvement made by any skilled familiar with the technical field within the spirit and principle of the present disclosure and within the technical scope of the present disclosure should be covered within the protection scope of the present disclosure.

What is claimed is:

1. A method for finely processing a nonmetallic mineral, comprising:
step 1, coarsely crushing a nonmetallic mineral to be processed by a jaw crusher or a hammer mill to obtain nonmetallic blocks; dry removing coarse granular magnetic irons with a high specific magnetization coefficient from the nonmetallic blocks by an open gradient drum and/or roller low magnetic field magnetic separator with a sorting magnetic flux density of 150-200 mT;
step 2, drying the nonmetallic blocks after removing coarse granular magnetic irons with a high specific magnetization coefficient obtained in step 1 at a temperature not higher than 300° C., and coarsely grinding at ambient temperature to obtain coarsely ground particles; subjecting the coarsely ground particles to a second grinding by a cyclone crusher, to obtain a secondary ground powder;
step 3, placing the secondary ground powder into a ball mill, dropwise adding a small amount of absolute ethyl alcohol, and mixing uniformly to obtain a mixture; ball milling the mixture for 10-15 min with zirconium dioxide grinding balls as a ball milling medium, to obtain a ball milled nonmetallic mineral powder; drying and sieving the ball milled nonmetallic mineral powder, to obtain a powder with various particle sizes;
step 4, wet removing fine granular metallic irons with a medium specific magnetization coefficient from the powder with various particle sizes by a closed gradient reciprocating permanent magnet multi-gradient magnetic separator with a sorting background magnetic field having a magnetic flux density of 300-600 mT and/or vertical ring multi-gradient magnetic separator with a sorting background magnetic field having a magnetic flux density of 600-1000 mT;
step 5, passing the powder with various particle sizes obtained in step 4 through two hydrocyclones with diameters of 75 mm and 50 mm in sequence to finely classify and mark the powder, thereby determining the grade and corresponding use of the powder;
step 6, selecting a nonmetallic mineral powder with a particle size lower than 150 μm obtained in step 5 and feeding a nonmetallic mineral powder with a particle size lower than 150 μm into a raw material bin inside a modification device through a feeding pipeline, and uniformly dispersing the nonmetallic mineral powder onto the surface of a pulse material dispersion filter bag by means of a blower mounted on the modification device;
step 7, coating a surface modifier on the nonmetallic mineral powder dispersed in step 6 by a fan-shaped high-pressure quantitative atomizing nozzle during the process that the nonmetallic mineral powder leaves the pulse material dispersion filter bag and descends, to obtain a coated nonmetallic mineral powder; drying the coated nonmetallic mineral powder by hot air delivered in an air supply device, to obtain a dried material;
step 8, re-feeding the dried material after descending to a collection device for the nonmetallic mineral powder into the fan-shaped high-pressure quantitative atomizing nozzle through a preheating pipeline by a distribution pipe and a distribution rotary valve arranged below the raw material bin for coating modification cycle for 3-5 times; discharging the material after coating modification from the modification device through a discharge pipeline, and grinding by a drum ultra-fine vibration mill, to obtain a modified nonmetallic mineral powder;
step 9, calcining the modified nonmetallic mineral powder obtained in step 8 in a calciner, cooling, and crushing to an extent that the powder passes through a 200-250 mesh sieve, to obtain a calcined modified nonmetallic mineral powder;
step 10, uniformly mixing the calcined modified nonmetallic mineral powder obtained in step 9 with a strong alkali solution in a mass ratio of 1:(3-8) to obtain a mixed liquid, and placing the mixed liquid in a thermostat water bath to react at a temperature of 60-90° C. for 2-5 h, to obtain a reacted mixed liquid; and
step 11, slowly adding a hydrochloric acid solution into the reacted mixed liquid obtained in step 10 until the hydrochloric acid in the reacted mixed liquid is excessive, to obtain a mixed liquid added with hydrochloric acid solution; filtering the mixed liquid added with hydrochloric acid solution to obtain a filter cake, circularly washing the filter cake with water and filtering until the filter cake is neutral, and then drying the filter cake, to obtain a purified nonmetallic mineral powder.

2. The method as claimed in claim 1, wherein in step 1, the nonmetallic mineral is at least one selected from the group consisting of graphite, crystal, barite, corundum, asbestos, mica, gypsum, fluorite, gem, jade, agate, limestone, dolomite, quartzite, diatomaceous earth, ceramic clay, refractory clay, marble, granite, salt ore and phosphate ore.

3. The method as claimed in claim 1, wherein in step 6, the modification device is controlled at a temperature of 150-180° C.

4. The method as claimed in claim 1, wherein in step 6, the pulse material dispersion filter bag is run by means of a blower at an air flow rate of 10000-12000 m³/min.

5. The method as claimed in claim 1, wherein in step 7, the surface modifier is at least one selected from the group consisting of a silane modifier, a titanate modifier, an aluminate modifier and a stearate modifier.

6. The method as claimed in claim 1, wherein in step 8, the grinding by a drum ultra-fine vibration mill is carried out for 30-60 min with ceramic balls as a grinding medium, and a weight ratio of the balls to the material is in a range of (8-10):1.

7. The method as claimed in claim 1, wherein in step 9, the modified nonmetallic mineral powder is calcined in a calciner at a temperature of 800-1200° C. for 5-8 h.

8. The method as claimed in claim 1, wherein in step 10, the strong alkali is at least one selected from the group consisting of sodium hydroxide, potassium hydroxide and lithium hydroxide; a concentration of the strong alkali in the strong alkali solution is in a range of 4-6 mol/L.

9. The method as claimed in claim 1, wherein in step 11, a concentration of the hydrochloric acid in the hydrochloric acid solution is in a range of 0.5-1 mol/L.

10. The method as claimed in claim 1, wherein in step 11, the filter cake is washed with water for 3-4 times, and dried in an oven at a temperature of 60-100° C. for 0.5-2.5 h.
